(19) United States
(12) Patent Application Publication
(10) Pub. No.: US 2013/0272018 A1
(43) Pub. Date: Oct. 17, 2013

(54) Light Source Including a Ball Lens for Use With a Scope

(71) Applicant: Vladimir Khubiryants, Winnipeg (CA)

(72) Inventor: Vladimir Khubiryants, Winnipeg (CA)

(21) Appl. No.: 13/604,758

(22) Filed: Sep. 6, 2012

Related U.S. Application Data
(60) Provisional application No. 61/564,420, filed on Nov. 29, 2011.

(51) Int. Cl. F21V 8/00

(52) U.S. Cl. CPC G02B 6/0005
USPC 362/574; 362/581

(57) ABSTRACT

A light source is releasably connected to a scope having a light guide including an input guide member and a connector about the input guide member. The light source includes an elongate housing, a solid state light emissive material at a first end of the housing, a controller which controllably illuminates the light emissive material, a ball lens supported in proximity to the light emissive material. A mounting socket at the first end of the housing is arranged for mating connection with the connector of the scope such that an input end face of the input guide member is in proximity to said ball lens diametrically opposite from the light emissive material while remaining readily separable from the ball lens. A transparent panel at an internal end of the mounting socket protects the ball lens even when the light source is disconnected from the scope.

This application claims the benefit under 35 U.S.C. 119(e) of U.S. provisional application Ser. No. 61/564,420, filed Nov. 29, 2011.

### FIELD OF THE INVENTION

The present invention relates to a light source for use with a scope, for example an endoscope, a boroscope, or a laryngoscope, in which the light source includes a ball lens supported in proximity to a solid state light emissive surface and a mounting socket for releasably supporting an input light guide of the scope in proximity to the ball lens opposite the light emissive surface.

### BACKGROUND

Endoscopes, like manner other types of scopes, typically include a light guide such as a fibre optic member for conveying light from a light source to a working end where the light is output to a target area of the scope. The scope often includes an input guide member such as a light post in the form of a glass or plastic rod which is cylindrical or tapered between an input end face at one end for communication with the light source and an opposing end in communication with the light guide.

Light sources for endoscopes typically rely on a solid state light emissive material of the type commonly found in a light emitting diode. The emissive material is coupled to a controller including a battery for controllably providing electrical power to the emissive material to control the illumination thereof. A suitable collimator, for example one or more lenses, is typically supported in communication with the light emitting surface to focus the emitted light onto the input end face of the input guide member on the scope.

One known method of focussing light from a light emitting surface onto the input end face of the scope is to use ball lenses in a series of lenses. Some related examples are described in U.S. Pat. Nos. 4,687,285 by Hily et al and 7,298,942 by Blasingame et al, and United States Patent Application Publication 2003/0083549 by Miyagi et al. In each instance the use of a ball lens requires a complex series of lenses for optimally focusing the light. Furthermore the mounting configuration in each instance is not well suited for ready connection to multiple different devices.

### SUMMARY OF THE INVENTION

According to one aspect of the invention there is provided a light source for releasable connection to a scope having a light guide including an input guide member having an input end face and a connector about the input guide member adjacent the input end face, the light source comprising:

an elongate housing extending between opposing first and second ends;

a solid state light emissive material supported at the first end of the housing;

a controller supported within the housing so as to be arranged to controllably illuminate the light emissive material;

a ball lens;

a seat member surrounding the ball lens and supporting the ball lens in fixed relation to the housing and in proximity to the light emissive material; and

a mounting socket supported at the first end of the housing and arranged for mating connection with the connector of the scope such that:
the input end face of the scope is supported in proximity to said ball lens diametrically opposite from the light emissive material; and
the input guide member of the scope is readily separable from the ball lens in proximity to the light emissive material.

By positioning a single ball lens directly between the light emissive material and the mounting socket receiving the input end face of the scope therein, the ball lens efficiently and effectively focuses light from the light emissive surface into the input guide member in a simple, low cost configuration. Furthermore, the proximity of the mounting socket to the ball lens allows the light source to be readily interchanged or mounted on different device.

The mounting socket preferably also includes a transparent panel at an internal end of the socket such that the ball lens remains protected even when the light source is disconnected from the scope.

A gap may be provided between the ball lens and the light emissive material.

The ball lens may be supported relative to the mounting socket such that there is arranged to be a gap between the ball lens and the input end face of the scope when the connector of the scope is mated with the mounting socket.

Preferably a diameter of the ball lens corresponds to approximately 2 to 5 times a corresponding dimension of the light emissive material and is approximately equal to a diameter of the input guide member of the scope.

The ball lens may be adhesively secured to the seat member.

Preferably a transparent panel is supported on the housing adjacent the ball lens diametrically opposite from the light emissive material such that the input end face of the scope is arranged to be mounted by the mounting socket in proximity to the transparent panel.

When the housing includes a main portion and a cap member releasably supported on the main portion at the first end of the housing, the cap member preferably supports the mounting socket and the transparent panel thereon such that the mounting socket and the transparent panel are removable from the main portion of the housing together with the cap member. The transparent panel defines at least a portion of an internal end face of the mounting socket.

Preferably the mounting socket comprises an internally threaded sleeve arranged for threaded connection with external threads on the connector about the input guide member and the mounting socket is pivotally supported on the housing.

When the housing includes a main portion and a cap member releasably supported on the main portion at the first end of the housing, the cap member may support the mounting socket rotatably thereon such that the mounting socket is pivotal relative to the cap member and the main portion of the housing.

The cap member may further comprise:
an axial bore having an internal end adjacent the ball lens;
a sleeve received within the axial bore having a main portion with an outer diameter which is less than an internal diameter of the axial bore to define an annular gap therebetween and an internal end flange projecting radially outward from the main portion adjacent the internal end of the axial bore; and
a retainer received within the annular gap between the sleeve and the axial bore in fixed relationship with the axial bore such that the internal end flange of the sleeve is axially fixed between the retainer ring and the internal end of the axial bore;
in which the mounting socket is formed on the sleeve such that the mounting socket is freely rotatable with the sleeve relative to the cap member.

The cap member may yet further comprise a transparent panel which defines at least a portion of the internal end of the mounting socket in proximity to the ball lens such that the transparent panel is arranged to be received between the input end face of the input guide member and the ball lens.

The retainer may comprise a ring member which is press-fit into the axially bore so as to be frictionally fixed in relation to the axial bore in the cap member.

The light source is preferably used in combination with the scope in which the input guide member comprises a light post and in which the input end face is supported in proximity to the ball lens diametrically opposite from the light emissive material.

The scope may comprise any one of various types, for example an endoscope, a boroscope, or a laryngoscope.

One embodiment of the invention will now be described in conjunction with the accompanying drawings in which:

### BRIEF DESCRIPTION OF THE DRAWINGS

FIG. 1 is an exploded, partly sectional, perspective view of the light source;

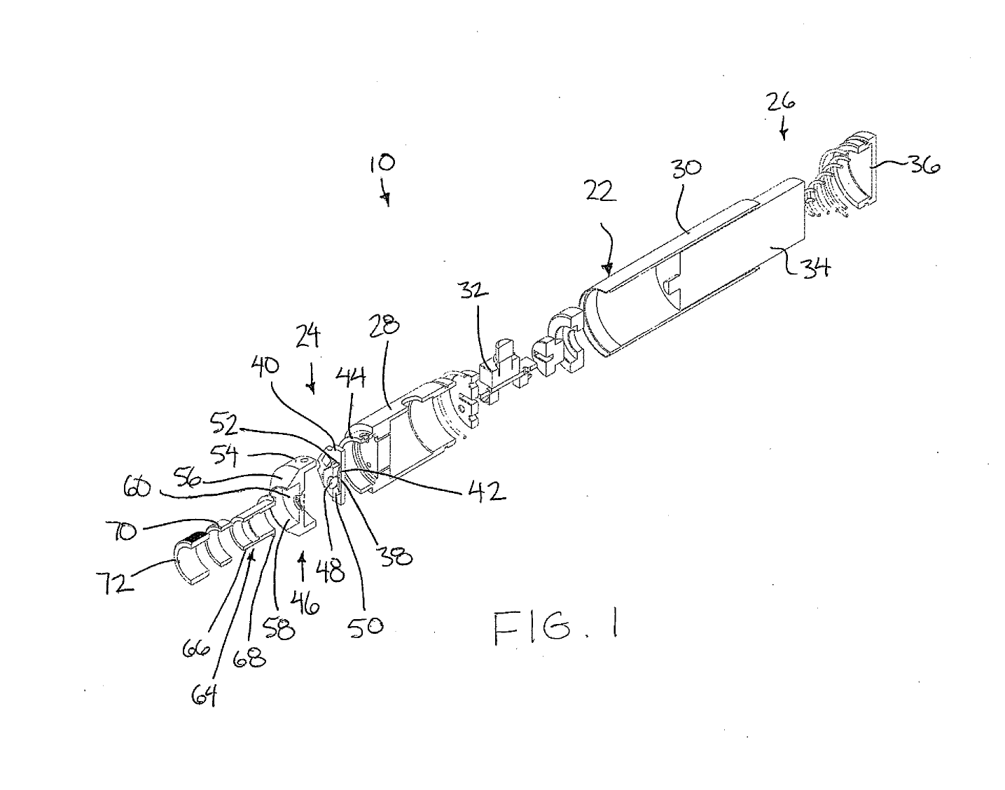

FIG. 2 is a partly sectional, perspective view of the assembled light source;

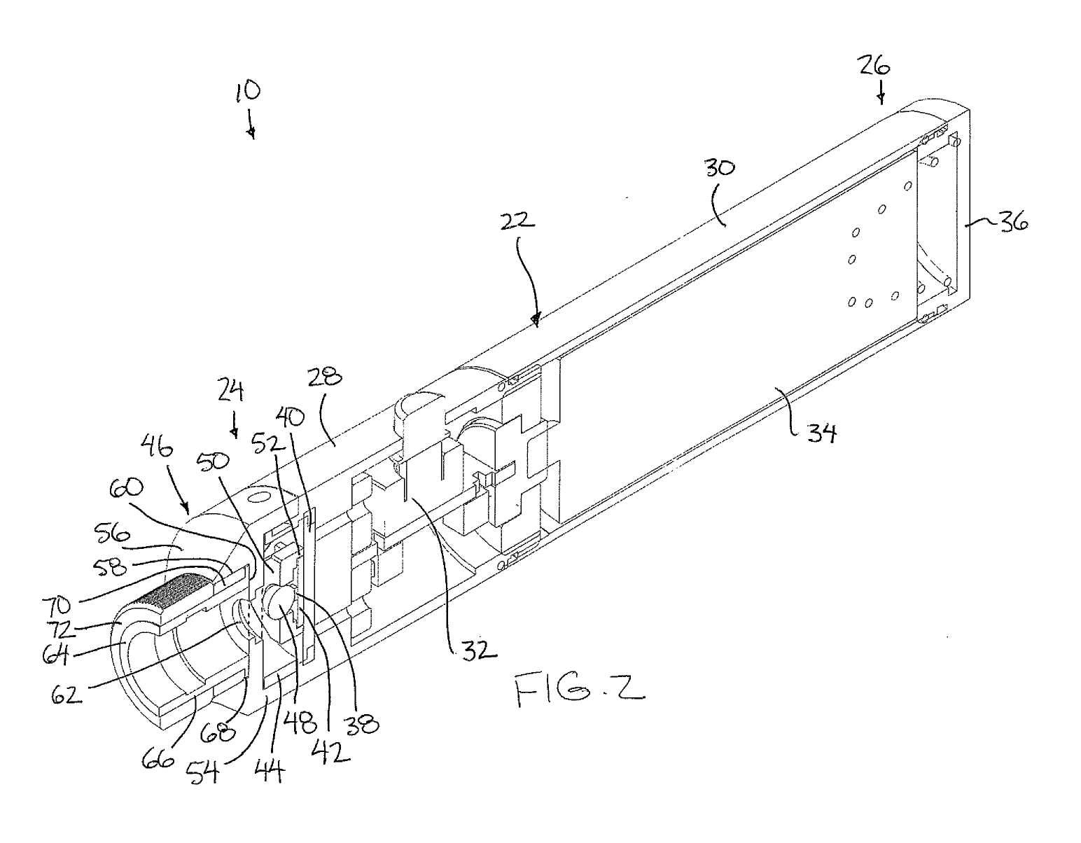

FIG. 3 is an enlarged perspective view of the cap member at the first end of the housing of the light source; and

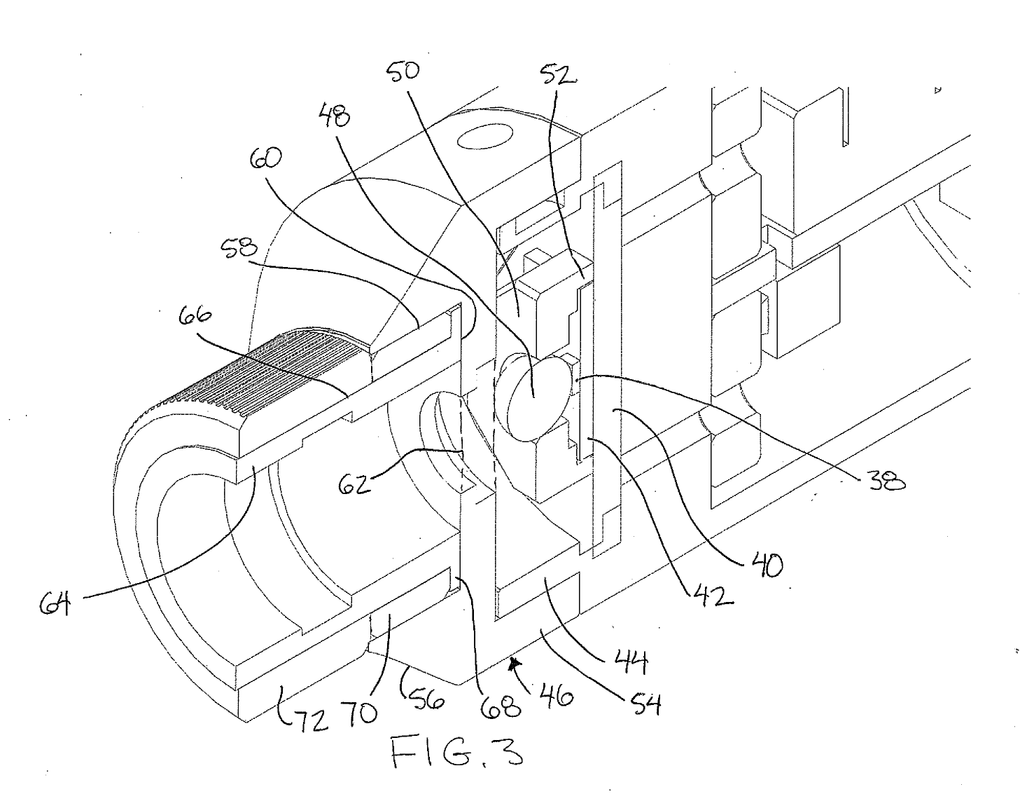

FIG. 4 is a sectional view of the light source connection to an endoscope.

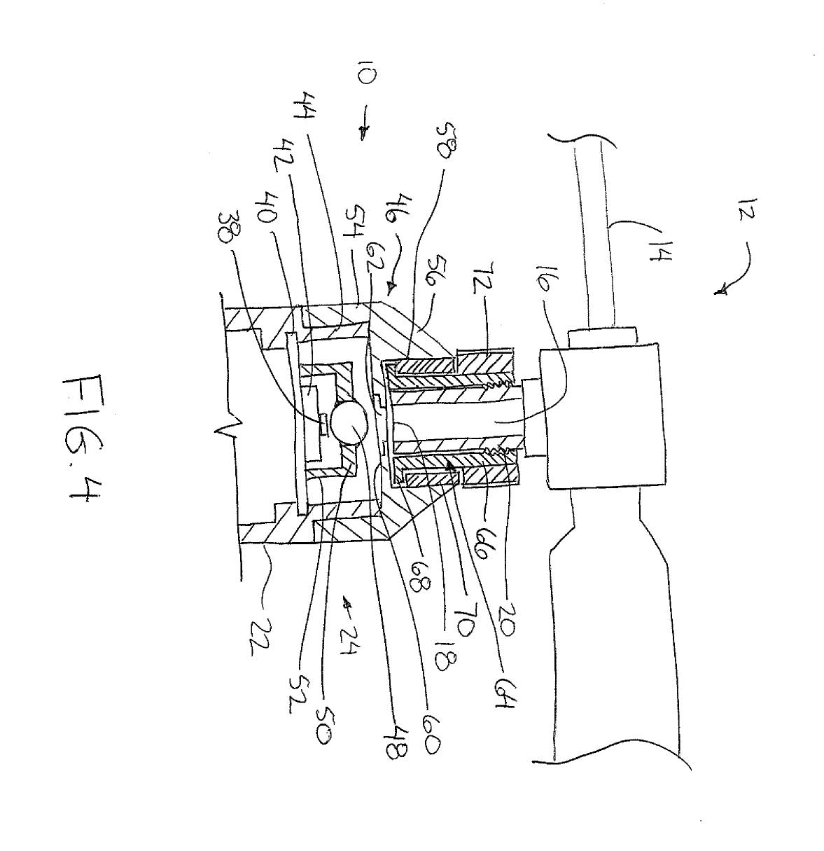

In the drawings like characters of reference indicate corresponding parts in the different figures.

### DETAILED DESCRIPTION

Referring to the accompanying figures, there is illustrated a light source 10 for use with various types of scopes 12.

In the illustrated embodiment, the light source is particularly suited for use with a scope comprising an endoscope. In the illustrated embodiment, the endoscope includes a fibre optic member 14 which serves as a light guide for conveying light to a first end from which the light is output to a working area of the scope. The same or different member is typically also provided on the scope for conveying an image illuminated by the light guide from the first end to an opposing second end of the scope for displaying to a user. At an intermediate location along the scope, there is provided an input guide member 16 for connection between the light guide 14 and the light source 10. In the illustrated embodiment the input guide member 16 comprises a light post in the form of a glass or plastic rod which may be cylindrical or somewhat tapered in shape from an input end face 18 opposite the fibre optic member 14 to an opposing output end in communication with the light guide. A connector 20 is also provided in the form of a tubular metallic sleeve about the light post which may be externally threaded for threaded connection to the light source.

The light source includes an elongate cylindrical housing 22 extending axially in a longitudinal direction between a first end 24 and an opposing second end 26. The housing includes a main portion comprised of a controller section 28 adjacent the first end and a battery section 30 adjacent the second end. The two sections are each defined by respective sleeves connected in series with one another to form a rigid outer casing of the housing. The sleeve of the controller section 28 houses components of a controller 32 therein as described in further detail below. Similarly the sleeve of the battery section 30 houses a battery 34 therein for providing electrical power to the controller. An end cap 36 is arranged to be mounted across the end of the battery section at the second end of the controller for selectively enclosing the battery within the battery section while permitting the battery to be replaced as required.

Light in the light source is produced from a solid state light emissive material 38 supported at the first end of the main portion of the housing. Electrical power is controlled by the controller 32 in the controller section which in turn receives power from the battery such that the controller is arranged to selectively illuminate the light emissive material by controlling the electrical power delivered to the material. The material is identical to the solid state emissive material found in conventional light emitting diodes but with the integral lens of the light emitting diode removed so that the light emissive material is directly exposed.

The first end of the housing includes a support wall 40 spanning across the housing perpendicularly to the longitudinal direction for supporting a circuit board 42 thereon such that the light emissive material 38 mounted on the circuit board is centrally located relative to the housing.

The housing further includes a collar portion 44 at the first end which is formed integrally with the controller section 28 to extend axially outward beyond the support wall 40 such that the collar portion surrounds the light emissive material 38 on the circuit board 42.

The housing further includes a cap member 46 which is mounted onto the collar portion 44 for enclosing the first end of the housing by surrounding and enclosing the light emissive material as described in further detail below.

A ball lens 48 provides a light collimating function by being mounted at the first end of the housing between the cap member and the support wall 40 so as to be enclosed within the housing by the cap member together with the light emissive material on the circuit board 42. The ball lens comprises a spherical lens of plastic or glass material which is supported by a seat member 50 so as to be located directly adjacent to an emitting surface of the light emissive material 38. The diameter of the ball lens is typically in the range of 4 to 5 millimetres so as to be substantially identical to the diameter of the light post at the input end face thereof. The light emissive material typically has a square emitting surface in the range of 1 to 2 millimetres in width by 1 to 2 millimetres in length. The diameter of the ball lens is thus typically equal to or greater than the corresponding surface dimension of the light emissive material, for example in the range of 2 to 5 times greater.

The seat member 50 comprises an annular member having a circular opening extending axially therethrough within which the ball lens is arranged to be frictionally received. The inner diameter of the opening is thus approximately equal to the outer diameter of the ball lens to snugly receive the lens therein. Adhesive may also be provided about the periphery of the ball lens only in the area of contact with the seat member to further fix the ball lens relative to the seat member. The seat member has a main portion which spans radially outward from the ball lens such that a dimension of the seat member perpendicular to the longitudinal direction is greater than the chip. Legs 52 of the seat member are arranged to be connected axially between an outer periphery of the main portion of the seat member and the support wall 40 at one or more locations about the periphery of the circuit board 42. The seat member supports the ball lens such that it is directly adjacent but not in direct contact with the light emissive material. For example a gap in the axial direction may be provided in the range of 1 to 2 millimetres between the ball lens and the light emissive material.

The cap member 46 of the housing includes a mounting portion 54 also in the form of a collar having an inner diameter which is greater than the outer diameter of the collar portion 44 such that the mounting portion can be secured over top of the collar portion by threaded connection, pin attachment or radial set screws for example. The body of the cap member further includes a conical portion 56 integral with the mounting portion but which tapers in diameter outwardly from the housing towards an outer end locating a mounting socket which mates with the connector 20 of the scope. The conical portion is thus frusto-conical in shape between the mounting portion and the mounting socket.

The cap member further includes an axial bore 58 at the outer end which receives the mounting socket therein. The axial bore is aligned with the axis of the housing so as to be coaxially aligned with the light emitting material. An internal end wall 60 of the bore is located at the junction of the mounting portion and the conical portion of the body of the cap member. When mounted onto the collar portion of the housing the end wall at the internal end of the bore 58 is located directly adjacent the ball lens diametrically opposite of the light emissive material.

An opening is formed centrally in the end wall which mounts a transparent panel 62 therein such that the panel spans perpendicularly to the axial direction and defines a portion of the internal end wall directly adjacent the ball lens. The ball lens is thus enclosed together with the light emissive material and the circuit board 42 at the first end of the housing between the support wall 40 and the cap member even when the light source is separated from the scope.

The mounting socket in the cap member is defined by a sleeve 64 received within the axial bore 58. The sleeve includes a main portion 66 which is generally cylindrical in shape and which has an outer diameter which is less than the internal diameter of the bore to define an annular gap therebetween. An end flange 68 is formed at the inner end of the main portion to project radially outward from the main portion adjacent the internal end wall of the bore. The outer diameter of the end flange is thus greater than the main portion while being near to the internal diameter of the bore. The sleeve projects axially outward beyond the body of the cap member when the end flange 68 is located adjacent the internal end wall 60.

A retainer 70 is provided to secure the sleeve within the bore while maintaining a rotatable relationship therebetween. The retainer comprises an annular ring member having an outer diameter which arranged for a compression friction fit within the internal diameter of the axial bore for mounting in fixed relation relative to one another. The internal diameter of the retainer 70 is less than the end flange 68 but greater than the main portion. Accordingly, the sleeve 64 remains freely rotatable relative to the retainer 70 and the surrounding body of the cap member within which the retainer is fixed while the end flange 68 remains fixed in the axial direction between the retainer 70 and the end wall 60 of the cap. The length of the retainer 70 in the axial direction corresponds approximately to the axial distance between the end flange 68 abutted with the end wall 60 and the outer end of the body of the cap member from which the remainder of the sleeve protrudes.

A grip ring 72 in the form of a cylindrical annular member is press fit onto the outer diameter of the portion of the sleeve protruding from the body of the cap member. The grip ring is equal in length to the protruding portion of the sleeve. An outer surface of the grip ring is textured for grip such that a user can readily manually rotate the sleeve relative to the body of the cap member.

The inner surface of the sleeve 64 is internally threaded to define the mounting socket therein which threadably connects to the connector 20 surrounding the light post. The threaded connection is such that in a mounted position, the input end face of the input guide member is located directly adjacent the transparent panel 62 which is in turn located in close proximity to the ball lens at a location diametrically opposite from the light emissive material. The transparent panel thus forms a window received between the ball lens and the input end face on the scope while maintaining the ball lens in an enclosed and protected environment even when the scope is separated from the light source.

In use the light source is assembled such that the ball lens, the seat member, the circuit board, and the light emissive material supported thereon are all supported on the support wall 40 at the first end of the housing in fixed relation. The collar portion of the housing surrounds these components which are then enclosed by the body of the cap member while permitting the light collimated by the ball lens to be projected through the transparent panel into the input end face of a light post received within the mounting socket of the light source. The mounting socket and the transparent panel forming the internal end wall of the socket are removable together with the body of the cap member for accessing the ball lens and light emitting material if required; however, typically, the cap member remains fixed on the first end of the housing. The user connects the light source by rotating the sleeve 64 defining the mounting socket relative to the cap member and remainder of the housing to form the threaded connection and to release the threaded connection with the connector 20 on the scope as desired. The input guide member of the scope remains readily separable from the components of the light source including the mounting socket, the ball lens, the light emissive material, and the housing upon which they are supported. The light source can thus be readily interchanged with other light sources of similar configuration. Alternatively, the light source can be interchangeably mounted on different types of scopes including endoscopes, boroscopes, laryngoscopes and the like.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A light source for releasable connection to a scope having a light guide including an input guide member having an input end face and a connector about the input guide member adjacent the input end face, the light source comprising:
an elongate housing extending between opposing first and second ends;
a solid state light emissive material supported at the first end of the housing;
a controller supported within the housing so as to be arranged to controllably illuminate the light emissive material;
a ball lens;
a seat member surrounding the ball lens and supporting the ball lens in fixed relation to the housing and in proximity to the light emissive material; and
a mounting socket supported at the first end of the housing and arranged for mating connection with the connector of the scope such that:
the input end face of the scope is supported in proximity to said ball lens diametrically opposite from the light emissive material; and
the input guide member of the scope is readily separable from the ball lens in proximity to the light emissive material.

2. The light source according to claim 1 wherein there is provide a gap between the ball lens and the light emissive material.

3. The light source according to claim 1 in combination with the scope wherein the ball lens is supported relative to the mounting socket such that there is arranged to be a gap between the ball lens and the input end face of the scope when the connector of the scope is mated with the mounting socket.

4. The light source according to claim 1 wherein a diameter of the ball lens corresponds to approximately 2 to 5 times a corresponding dimension of the light emissive material.

5. The light source according to claim 1 in combination with the scope wherein a diameter of the ball lens is approximately equal to a diameter of the input guide member of the scope.

6. The light source according to claim 1 wherein the ball lens is adhesively secured to the seat member.

7. The light source according to claim 1 further comprising a transparent panel supported on the housing adjacent the ball lens diametrically opposite from the light emissive material such that the input end face of the scope is arranged to be mounted by the mounting socket in proximity to the transparent panel.

8. The light source according to claim 7 wherein the housing includes a main portion and a cap member releasably supported on the main portion at the first end of the housing, the cap member supporting the mounting socket and the transparent panel thereon such that the mounting socket and the transparent panel are removable from the main portion of the housing together with the cap member.

9. The light source according to claim 8 wherein the transparent panel defines at least a portion of an internal end face of the mounting socket.

10. The light source according to claim 1 wherein the mounting socket comprises an internally threaded sleeve arranged for threaded connection with external threads on the connector about the input guide member, the mounting socket being pivotally supported on the housing.

11. The light source according to claim 10 wherein the housing includes a main portion and a cap member releasably supported on the main portion at the first end of the housing, the cap member supporting the mounting socket rotatably thereon such that the mounting socket is pivotal relative to the cap member and the main portion of the housing.

12. The light source according to claim 11 wherein the cap member further comprises:
an axial bore having an internal end adjacent the ball lens;
a sleeve received within the axial bore having a main portion with an outer diameter which is less than an internal diameter of the axial bore to define an annular gap therebetween and an internal end flange projecting radially outward from the main portion adjacent the internal end of the axial bore; and
a retainer received within the annular gap between the sleeve and the axial bore in fixed relationship with the axial bore such that the internal end flange of the sleeve is axially fixed between the retainer ring and the internal end of the axial bore;
the mounting socket being formed on the sleeve such that the mounting socket is freely rotatable with the sleeve relative to the cap member.

13. The light source according to claim 12 wherein the cap member further comprises a transparent panel which defines at least a portion of the internal end of the mounting socket in proximity to the ball lens such that the transparent panel is arranged to be received between the input end face of the input guide member and the ball lens.

14. The light source according to claim 12 wherein the retainer comprises a ring member which is press-fit into the axially bore so as to be frictionally fixed in relation to the axial bore in the cap member.

15. The light source according to claim 1 in combination with the scope in which the input guide member comprises a light post in which the input end face is supported in proximity to the ball lens diametrically opposite from the light emissive material.

16. The light source according to claim 1 in combination with the scope wherein the scope comprises an endoscope.

17. The light source according to claim 1 in combination with the scope wherein the scope comprises a boroscope.

18. The light source according to claim 1 in combination with the scope wherein the scope comprises a laryngoscope.
